(19) United States
(12) Patent Application Publication
(10) Pub. No.: US 2023/0278575 A1
(43) Pub. Date: Sep. 7, 2023

(54) CONTROL DEVICE, CONTROL METHOD, AND COMPUTER-READABLE RECORDING MEDIUM

(71) Applicant: HONDA MOTOR CO., LTD., Tokyo (JP)

(72) Inventors: Gaku SHIMAMOTO, Tokyo (JP); Jumpei NOGUCHI, Tokyo (JP)

(73) Assignee: HONDA MOTOR CO., LTD., Tokyo (JP)

(21) Appl. No.: 18/110,075

(22) Filed: Feb. 15, 2023

(30) Foreign Application Priority Data
Mar. 4, 2022 (JP) 2022-033655

(51) Int. Cl. B60W 50/14; B60W 30/06

(52) U.S. Cl. CPC B60W 50/14; B60W 30/06; B60W 2540/215

(57) ABSTRACT

A control device of a moving object includes: a controller configured to perform parking control and exit control of the moving object and receive an action plan of the exit control. The controller is configured to receive the action plan in advance during the parking control; when the action plan is not received in advance during the exit control, the controller receives the action plan and performs the exit control based on the received action plan; and when the action plan is received in advance during the exit control, the controller performs the exit control based on the action plan received in advance.

### CROSS-REFERENCE TO RELATED APPLICATIONS

This application is based on and claims priority under 35 USC 119 from Japanese Patent Application No. 2022-033655 filed on Mar. 4, 2022, the contents of which are incorporated herein by reference.

### TECHNICAL FIELD

The present disclosure relates to a control device, a control method, and a computer-readable recording medium.

### BACKGROUND ART

In recent years, it is required to improve traffic safety to make cities and human settlements inclusive, safe, resilient, and sustainable. In a vehicle, from the viewpoint of improving traffic safety, for example, it is required to ensure traffic safety even when an abnormality occurs in the vehicle.

In the related art, there is known a remote parking system that remotely operates a vehicle to park the vehicle in a designated predetermined parking space or to cause the vehicle to exit the parking space. Japanese Patent Publication No. JP6795036B (hereinafter, referred to as Patent Literature 1) discloses an exit assistance device that changes an exit route of a vehicle according to whether another vehicle is present in an adjacent parking space when the vehicle is to exit a parking space.

According to the exit assistance device disclosed in Patent Literature 1, it is possible to select an exit direction according to a surrounding situation when the vehicle exits.

However, at the time of exit, since the user is about to start driving, the user is mentally occupied due to tension of driving, and thus it is burdensome for the user to input an action plan (selection of the exit direction) into the device at the time of exit.

An object of the present disclosure is to provide a control device, a control method, and a computer-readable recording medium that stores a control program that are capable of reducing a burden on a user during autonomous exit of a moving object.

### SUMMARY

A first aspect of the present disclosure relates to a control device of a moving object, including:
a controller configured to perform parking control and exit control of the moving object and receive an action plan of the exit control, in which
the controller is configured to receive the action plan in advance during the parking control;
when the action plan is not received in advance during the exit control, the controller receives the action plan and performs the exit control based on the received action plan; and
when the action plan is received in advance during the exit control, the controller performs the exit control based on the action plan received in advance.

A second aspect of the present disclosure relates to a control method performed by a processor of a control device, in which
the processor is configured to perform parking control and exit control of a moving object and receives an action plan of the exit control,
the processor is configured to receive the action plan in advance during the parking control, and
the control method comprises:
when the action plan is not received in advance during the exit control, receiving the action plan and performs the exit control based on the received action plan; and
when the action plan is received in advance during the exit control, performing the exit control based on the action plan received in advance.

A third aspect of the present disclosure relates to a non-transitory computer-readable recording medium storing a control program for causing a processor of a control device to execute a process, in which
the processor is configured to perform parking control and exit control of a moving object and receive an action plan of the exit control, and
the process includes:
enabling reception of the action plan in advance during the parking control;
when the action plan is not received in advance during the exit control, receiving the action plan and performing the exit control based on the received action plan; and
when the action plan is received in advance during the exit control, performing the exit control based on the action plan received in advance.

According to the present disclosure, it is possible to provide a control device, a control method, and a recording medium that stores a control program that are capable of reducing a burden on a user during autonomous exit of a moving object.

### BRIEF DESCRIPTION OF DRAWINGS

Exemplary embodiment(s) of the present disclosure will be described in detail based on the following figures, wherein:

FIG. 1 is a side view showing an example of a vehicle whose movement is controlled by a control device according to an embodiment;

FIG. 2 is a top view of the vehicle shown in FIG. 1;

FIG. 3 is a block diagram showing an internal configuration of the vehicle shown in FIG. 1;

FIG. 4 shows an example of a hardware configuration of an information terminal;

FIG. 5 shows a state in which parking instruction control of the vehicle is performed by using the information terminal from outside of the vehicle;

FIG. 6 is a flowchart showing the parking instruction control performed by the information terminal during autonomous parking;

FIG. 7 is a flowchart showing the parking instruction control performed by the information terminal during autonomous parking;

FIG. 8 shows an example of a child protection screen displayed on the information terminal during autonomous parking;

FIG. 9 shows an example of a disclaimer notification and agreement screen displayed on the information terminal during autonomous parking;

FIG. 10 shows an example of a connection-with-vehicle screen displayed on the information terminal during autonomous parking;

FIG. 11 shows an example of an alighting guidance screen displayed on the information terminal during autonomous parking;

FIG. 12 shows an example of an action plan screen displayed on the information terminal during autonomous parking;

FIG. 13 shows an example of an operation input start screen displayed on the information terminal during autonomous parking;

FIG. 14 shows an example of an operation input screen displayed on the information terminal during autonomous parking;

FIG. 15 shows an example of an autonomous parking completion screen displayed on the information terminal during autonomous parking;

FIG. 16 shows an example of an exit direction selection screen displayed on the information terminal during autonomous parking;

FIG. 17 shows an example of an exit direction determination screen displayed on the information terminal during autonomous parking;

FIG. 18 is a flowchart showing exit instruction control performed by the information terminal during autonomous exit;

FIG. 19 is a flowchart showing the exit instruction control performed by the information terminal during autonomous exit;

FIG. 20 shows an example of an autonomous exit guidance screen displayed on the information terminal during autonomous exit;

FIG. 21 shows an example of an exit instruction screen displayed on the information terminal during autonomous exit;

FIG. 22 shows an example of an ignition-on screen displayed on the information terminal during autonomous exit;

FIG. 23 shows an example of an operation input start screen displayed on the information terminal during autonomous exit;

FIG. 24 shows an example of an operation input screen displayed on the information terminal during autonomous exit; and

FIG. 25 shows an example of an autonomous exit completion screen displayed on the information terminal during autonomous exit.

### DESCRIPTION OF EMBODIMENTS

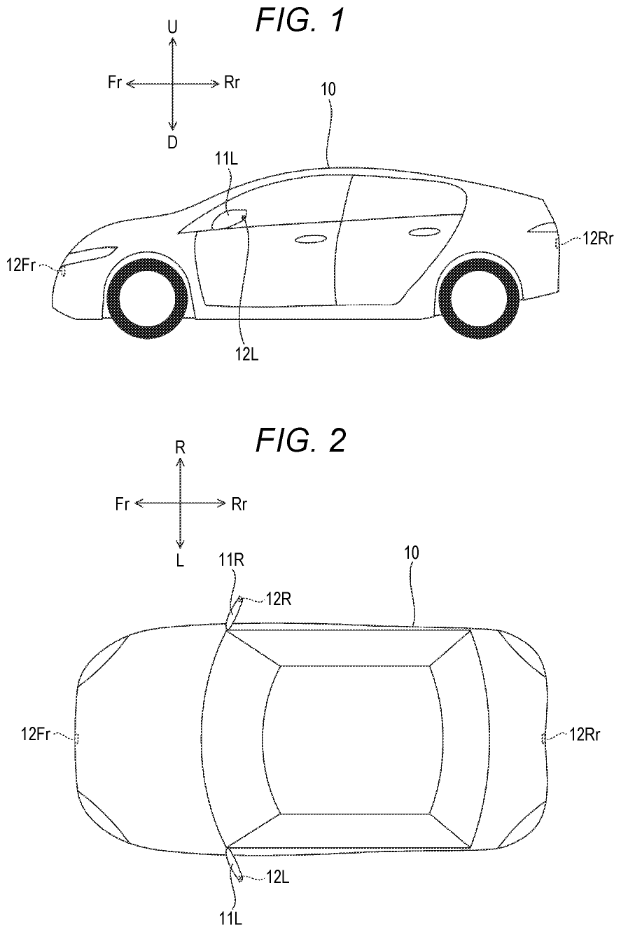

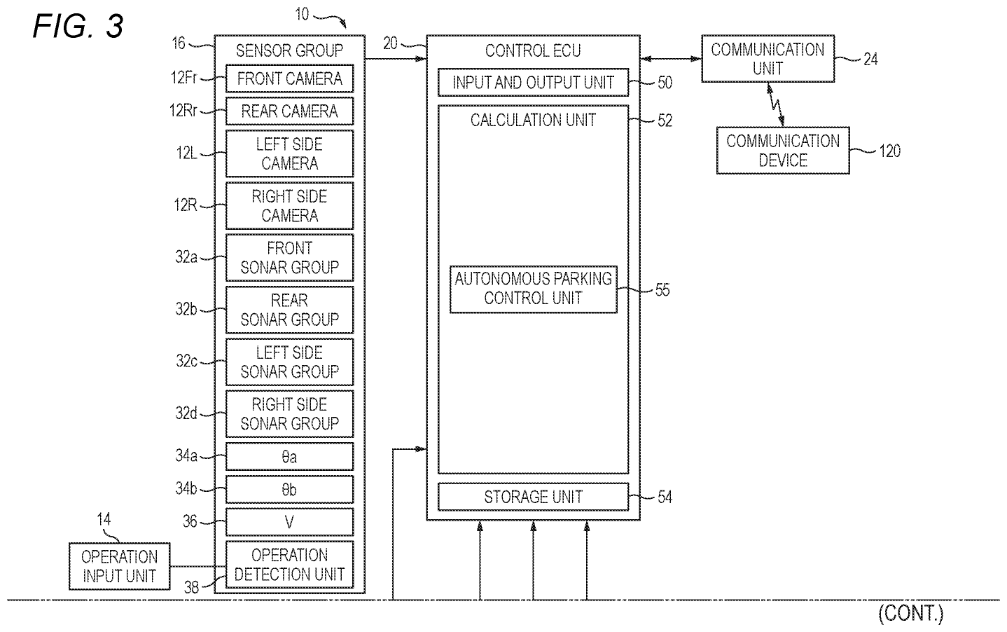

Hereinafter, an embodiment of a control device, a control method, and a recording medium that stores a control program according to the present disclosure will be described with reference to the accompanying drawings. The drawings are viewed in directions of reference signs. In addition, in the present specification and the like, in order to simplify and clarify the description, a front-rear direction, a left-right direction, and an up-down direction are described according to directions viewed from a driver of a vehicle 10 shown in FIGS. 1 and 2. In the drawings, a front side of the vehicle 10 is denoted by Fr, a rear side thereof is denoted by Rr, a left side thereof is denoted by L, a right side thereof is denoted by R, an upper side thereof is denoted by U, and a lower side thereof is denoted by D.

### <Vehicle 10 Whose Movement is Controlled by Control Device According to Present Disclosure>

FIG. 1 is a side view of the vehicle 10 whose movement is controlled by the control device according to the present disclosure. FIG. 2 is a top view of the vehicle 10 shown in FIG. 1. The vehicle 10 is an example of a moving object in the disclosure.

The vehicle 10 is an automobile including a driving source (not shown) and wheels including driving wheels driven by power of the driving source and steerable wheels that are steerable. In the present embodiment, the vehicle 10 is a four-wheeled automobile including a pair of left and right front wheels and a pair of left and right rear wheels. The driving source of the vehicle 10 is, for example, an electric motor. The driving source of the vehicle 10 may also be an internal combustion engine such as a gasoline engine or a diesel engine, or a combination of an electric motor and an internal combustion engine. In addition, the driving source of the vehicle 10 may drive the pair of left and right front wheels, the pair of left and right rear wheels, or four wheels, that is, the pair of left and right front wheels and the pair of left and right rear wheels. The front wheels and the rear wheels may both be steerable wheels that are steerable, or one of the front wheels and the rear wheels may be steerable wheels that are steerable.

The vehicle 10 further includes side mirrors 11L and 11R. The side mirrors 11L and 11R are mirrors (rearview mirrors) that are provided outside front seat doors of the vehicle 10 for the driver to check a rear side and a rear lateral side. Each of the side mirrors 11L and 11R is fixed to a body of the vehicle 10 by a rotation shaft extending in a vertical direction and can be opened and closed by rotating about the rotation shaft.

The vehicle 10 further includes a front camera 12Fr, a rear camera 12Rr, a left side camera 12L, and a right side camera 12R. The front camera 12Fr is a digital camera that is provided at a front portion of the vehicle 10 and captures an image of a front side of the vehicle 10. The rear camera 12Rr is a digital camera that is provided at a rear portion of the vehicle 10 and captures an image of a rear side of the vehicle 10. The left side camera 12L is a digital camera that is provided on the left side mirror 11L of the vehicle 10 and captures an image of a left side of the vehicle 10. The right side camera 12R is a digital camera that is provided on the right side mirror 11R of the vehicle 10 and captures an image of a right side of the vehicle 10.

### <Internal Configuration of Vehicle 10>

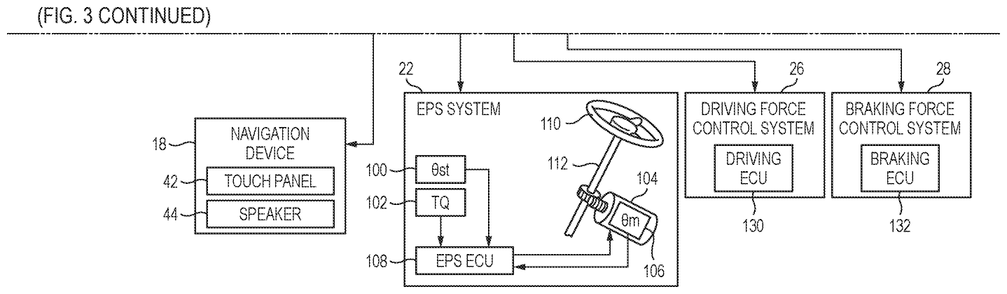

FIG. 3 is a block diagram showing an example of an internal configuration of the vehicle 10 shown in FIG. 1. As shown in FIG. 3, the vehicle 10 includes a sensor group 16, a navigation device 18, a control electronic control unit (ECU) 20, an electric power steering (EPS) system 22, and a communication unit 24. The vehicle 10 further includes a driving force control system 26 and a braking force control system 28.

The sensor group 16 acquires various detection values used for control performed by the control ECU 20. The sensor group 16 includes the front camera 12Fr, the rear camera 12Rr, the left side camera 12L, and the right side camera 12R. In addition, the sensor group 16 includes a front sonar group 32a, a rear sonar group 32b, a left side sonar group 32c, and a right side sonar group 32d. In addition, the sensor group 16 includes wheel sensors 34a and 34b, a vehicle speed sensor 36, and an operation detection unit 38.

The front camera 12Fr, the rear camera 12Rr, the left side camera 12L, and the right side camera 12R acquire recognition data (for example, a surrounding image) for recognizing outside of the vehicle 10 by capturing images of surroundings of the vehicle 10. Surrounding images captured by the front camera 12Fr, the rear camera 12Rr, the left side camera 12L, and the right side camera 12R are referred to as a front image, a rear image, a left side image, and a right side image, respectively. An image formed by the left side image and the right side image may be referred to as a side image.

The front sonar group 32a, the rear sonar group 32b, the left side sonar group 32c, and the right side sonar group 32d emit sound waves to the surroundings of the vehicle 10 and receive reflected sounds from other objects. The front sonar group 32a includes, for example, four sonars. The sonars constituting the front sonar group 32a are respectively provided on an obliquely left front side, a front left side, a front right side, and an obliquely right front side of the vehicle 10. The rear sonar group 32b includes, for example, four sonars. The sonars constituting the rear sonar group 32b are respectively provided on an obliquely left rear side, a rear left side, a rear right side, and an obliquely right rear side of the vehicle 10. The left side sonar group 32c includes, for example, two sonars. The sonars constituting the left side sonar group 32c are provided in the front of a left side portion of the vehicle 10 and the rear of the left side portion, respectively. The right side sonar group 32d includes, for example, two sonars. The sonars constituting the right side sonar group 32d are provided in the front of a right side portion of the vehicle 10 and the rear of the right side portion, respectively.

The wheel sensors 34a and 34b detect a rotation angle of the wheel of the vehicle 10. The wheel sensors 34a and 34b may be implemented by angle sensors or displacement sensors. The wheel sensors 34a and 34b output detection pulses each time the wheel rotates by a predetermined angle. The detection pulses output from the wheel sensors 34a and 34b are used to calculate the rotation angle of the wheel and a rotation speed of the wheel. A movement distance of the vehicle 10 is calculated based on the rotation angle of the wheel. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a countershaft of a transmission.

The operation detection unit 38 detects a content of an operation performed by a user (in other words, what the user did as the operation) using an operation input unit 14 and outputs the detected content of the operation to the control ECU 20. The operation input unit 14 includes, for example, various user interfaces such as a side mirror switch that switches opened and closed states of the side mirrors 11L and 11R, and a shift lever (a select lever or a selector).

The navigation device 18 detects a current position of the vehicle 10 by using, for example, a global positioning system (GPS), and guides the user along a route toward a destination. The navigation device 18 includes a storage device (not shown) that includes a map information database.

The navigation device 18 includes a touch panel 42 and a speaker 44. The touch panel 42 functions as an input device and a display device of the control ECU 20. The speaker 44 outputs various types of guidance information to the user of the vehicle 10 by voice.

The touch panel 42 is configured to input various commands to the control ECU 20. For example, the user can input a command related to movement assistance of the vehicle 10 via the touch panel 42. The movement assistance includes parking assistance and exit assistance for the vehicle 10. In addition, the touch panel 42 is configured to display various screens related to a control content of the control ECU 20 (in other words, how the control ECU 20 controls). For example, a screen related to the movement assistance of the vehicle 10 is displayed on the touch panel 42. Specifically, a parking assistance button for requesting parking assistance for the vehicle 10 and an exit assistance button for requesting exit assistance are displayed on the touch panel 42. The parking assistance button includes an autonomous parking button for requesting parking by autonomous steering of the control ECU 20 and a support parking button for requesting support when parking by an operation of the driver. The exit assistance button includes an autonomous exit button for requesting exit by autonomous steering of the control ECU 20 and a support exit button for requesting support when exiting by an operation of the driver. Constituent elements other than the touch panel 42, for example, a smartphone or a tablet terminal may be used as the input device or the display device.

The control ECU 20 includes an input and output unit 50, a calculation unit 52, and a storage unit 54. The calculation unit 52 is implemented by, for example, a central processing unit (CPU). The calculation unit 52 performs various types of control by controlling each unit based on a program stored in the storage unit 54. In addition, the calculation unit 52 receives and outputs signals from and to each unit connected to the control ECU 20 via the input and output unit 50.

The calculation unit 52 includes an autonomous parking control unit 55 configured to perform movement execution control of the vehicle 10. The autonomous parking control unit 55 performs autonomous parking assistance and autonomous exit assistance of the vehicle 10 by autonomous steering in which a steering wheel 110 is autonomously operated under control of the autonomous parking control unit 55. In the autonomous parking assistance and the autonomous exit assistance, an accelerator pedal (not shown), a brake pedal (not shown), and the operation input unit 14 are autonomously operated. In addition, the autonomous parking control unit 55 performs support parking assistance and support exit assistance when the driver performs manual parking and manual exit of the vehicle 10 by operating the accelerator pedal, the brake pedal, and the operation input unit 14.

For example, based on the recognition data of the outside of the vehicle 10 acquired by the front camera 12Fr, the rear camera 12Rr, the left side camera 12L, and the right side camera 12R and a parking space designated by the user, the autonomous parking control unit 55 performs parking execution control for autonomously parking the vehicle 10 in the predetermined parking space and exit execution control for causing the vehicle 10 to autonomously exit the predetermined parking space. The autonomous parking control unit 55 performs the execution control of autonomous parking and autonomous exit based on a movement instruction signal input from outside (an information terminal to be described later) via the input and output unit 50. In addition, the autonomous parking control unit 55 transmits information related to the execution control of autonomous parking and autonomous exit to the external information terminal via the input and output unit 50.

The EPS system 22 includes a steering angle sensor 100, a torque sensor 102, an EPS motor 104, a resolver 106, and an EPS ECU 108. The steering angle sensor 100 detects a steering angle θst of the steering wheel 110. The torque sensor 102 detects a torque TQ applied to the steering wheel 110.

The EPS motor 104 applies a driving force or a reaction force to a steering column 112 connected to the steering wheel 110, thereby enabling assistance of an operation performed by an occupant on the steering wheel 110 and enabling autonomous steering during parking assistance. The resolver 106 detects a rotation angle Gm of the EPS motor 104. The EPS ECU 108 controls the entire EPS system 22. The EPS ECU 108 includes an input and output unit (not shown), a calculation unit (not shown), and a storage unit (not shown).

The communication unit 24 enables wireless communication with another communication device 120. The other communication device 120 is a base station, a communication device of another vehicle, a smartphone or a tablet terminal carried by the user of the vehicle 10, or the like. An information terminal such as a smartphone or a tablet is an example of a control device according to the present disclosure.

The driving force control system 26 includes a driving ECU 130. The driving force control system 26 executes driving force control of the vehicle 10. The drive ECU 130 controls a driving force of the vehicle 10 by controlling an engine or the like (not shown) based on an operation performed on the accelerator pedal (not shown) by the user.

The braking force control system 28 includes a braking ECU 132. The braking force control system 28 executes braking force control of the vehicle 10. The braking ECU 132 controls a braking force of the vehicle 10 by controlling a brake mechanism (not shown) or the like based on an operation performed on the brake pedal (not shown) by the user.

### <Hardware Configuration of Information Terminal>

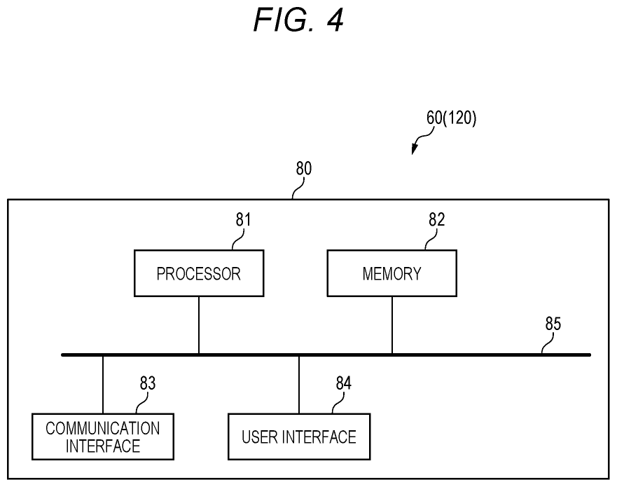

FIG. 4 shows an example of a hardware configuration of an information terminal 60. Hardware of the information terminal 60 may be implemented by, for example, an information processing device 80 shown in FIG. 4. The information processing device 80 includes a processor 81, a memory 82, a communication interface 83, and a user interface 84. The processor 81, the memory 82, the communication interface 83, and the user interface 84 are connected by, for example, a bus 85.

The processor 81 is a circuit that performs signal processing, and is, for example, a central processing unit (CPU) that controls the entire information processing device 80. The processor 81 is an example of a control unit in the present disclosure. The processor 81 may be implemented by another digital circuit such as a field programmable gate array (FPGA) or a digital signal processor (DSP). In addition, the processor 81 may be implemented by combining a plurality of digital circuits.

The memory 82 includes, for example, a main memory and an auxiliary memory. The main memory is, for example, a random access memory (RAM). The main memory is used as a work area of the processor 81.

The auxiliary memory is, for example, a nonvolatile memory such as a magnetic disk, an optical disk, or a flash memory. Various programs for operating the information processing device 80 are stored in the auxiliary memory. The programs stored in the auxiliary memory are loaded onto the main memory and executed by the processor 81.

In addition, the auxiliary memory may include a portable memory removable from the information processing device 80. Examples of the portable memory include a universal serial bus (USB) flash drive, a memory card such as a secure digital (SD) memory card, and an external hard disk drive.

The communication interface 83 is a communication interface that performs wireless communication with outside of the information processing device 80 (for example, the communication unit 24 of the vehicle 10). The communication interface 83 is controlled by the processor 81.

The user interface 84 includes, for example, an input device that receives an operation input from the user and an output device that outputs information to the user. The input device can be implemented by, for example, a touch panel. The output device can be implemented by, for example, a display and a speaker. The user interface 84 is controlled by the processor 81.

For example, the processor 81 performs movement instruction control instructing movement of the vehicle 10. Specifically, the processor 81 performs the movement instruction control of the vehicle 10 based on an operation performed by the user on a terminal screen of the information terminal 60. The movement instruction control includes, for example, parking instruction control for autonomously parking the vehicle 10 in a predetermined parking space and exit instruction control for causing the vehicle 10 to autonomously exit the predetermined parking space. Specifically, in the exit instruction control, the processor 81 receives an autonomous exit action plan of the vehicle 10. The autonomous exit action plan is a plan related to autonomous exit of the vehicle 10, and includes, for example, a plan of a direction in which the vehicle 10 exits (an exit direction of the vehicle 10) when the vehicle 10 exits the space in which the vehicle 10 is parked. The processor 81 can receive the autonomous exit action plan in advance during parking control. The time during the parking control is, for example, a time point at which autonomous parking of the vehicle 10 in the parking space is completed. The processor 81 receives the autonomous exit action plan based on an input operation performed on the terminal screen of the information terminal 60. When the autonomous exit action plan is received, the processor 81 discards the received action plan after a predetermined time since the time point when the action plan is received. When the vehicle 10 is to autonomously exit, the processor 81 transmits an exit instruction signal for causing the vehicle 10 to autonomously exit to the vehicle 10 based on the received action plan. An application capable of controlling movement of the vehicle 10 by transmitting and receiving information related to the movement control of the vehicle 10 to and from the vehicle 10 is installed in the information terminal 60.

### <Example of Movement Instruction Control Performed by Information Terminal 60>

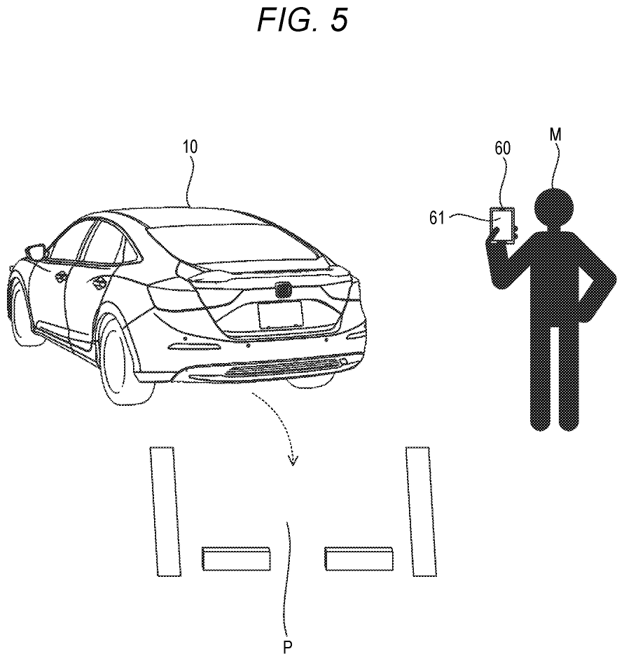

FIG. 5 shows an example of a state in which a user M of the vehicle 10 performs parking instruction control for autonomously parking the vehicle 10 in a parking space P by using the information terminal 60 carried by the user M from outside of the vehicle 10.

When the user M touches a terminal screen 61 configured as a touch panel, the information terminal 60 transmits a parking instruction signal instructing autonomous parking of the vehicle 10 to the vehicle 10 by wireless communication. As the wireless communication between the information terminal 60 and the vehicle 10, for example, BLE (Bluetooth Low Energy, registered trademark), NFC (Near Field Communication, registered trademark), or UWB (Ultra Wide Band, registered trademark) is used. The vehicle 10 receives the parking instruction signal from the information terminal 60 by the autonomous parking control unit 55 and performs parking execution control for autonomously parking the vehicle in the parking space P according to the received parking instruction signal.

<Processing Performed by Information Terminal 60 during Autonomous Parking>

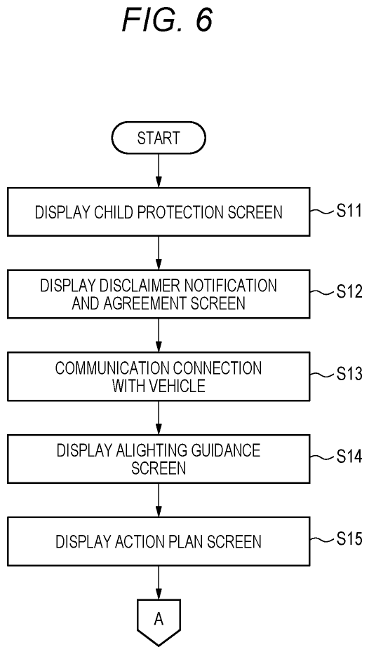

Next, an example of parking instruction control performed by the information terminal 60 during autonomous parking will be described with reference to FIGS. 6 to 17.

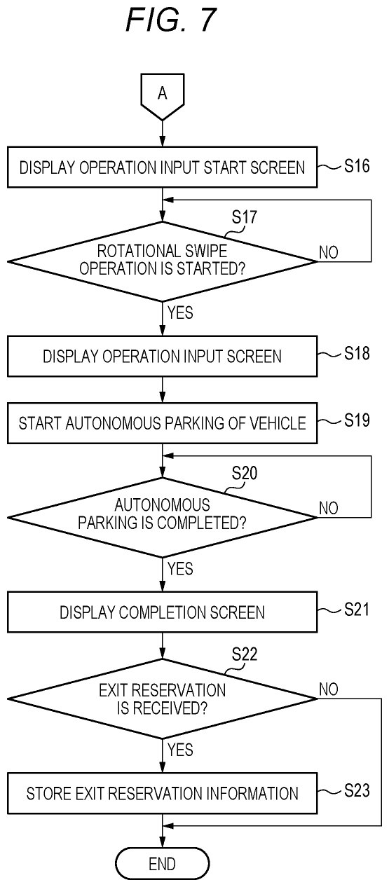

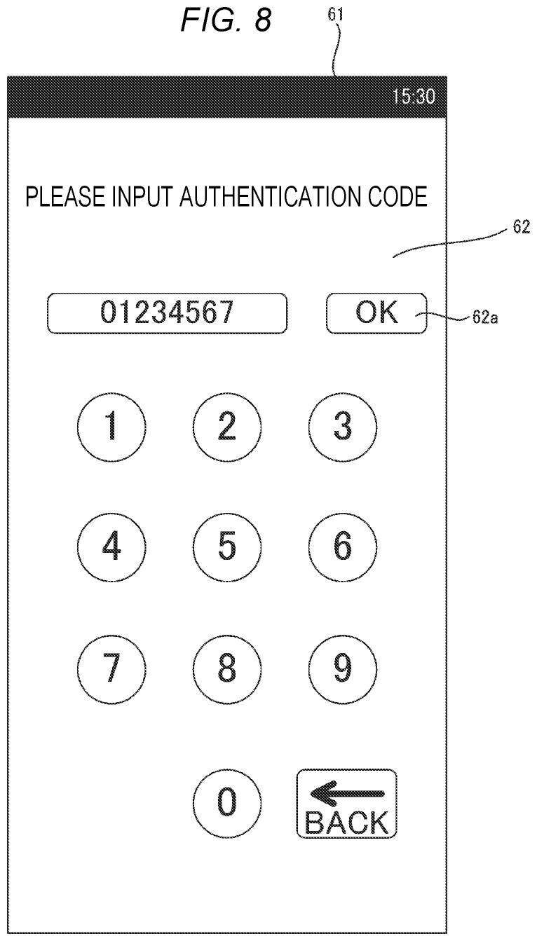

FIGS. 6 and 7 are flowcharts showing the parking instruction control performed by the information terminal 60 during autonomous parking. FIGS. 8 to 17 show examples of images displayed on the information terminal 60 during autonomous parking.

For example, the user M who drives the vehicle 10 attempts to autonomously park the vehicle 10 in a vacant parking space in a certain parking lot. When an autonomous parking button (not shown) displayed on the touch panel 42 of the navigation device 18 is touched by the user M, an overhead view image of the surroundings of the vehicle 10 acquired by the front camera 12Fr, the rear camera 12Rr, the left side camera 12L, and the right side camera 12R is displayed on the touch panel 42. Further, when the parking space in which the vehicle is to be parked is selected by the user M on the touch panel 42, the selection of the parking space is received by the autonomous parking control unit 55 of the vehicle 10.

For example, the user M gets off the vehicle 10 while carrying the information terminal 60 (see FIG. 5), and launches an autonomous parking application installed in the information terminal 60 to autonomously park the vehicle 10. The process shown in FIG. 6 is started by launching the autonomous parking application in the information terminal 60.

The processor 81 of the information terminal 60 displays, for example, a child protection screen 62 as shown in FIG. 8 on the terminal screen 61 of the information terminal 60 (step S11). After a predetermined authentication code is input by the user M to the child protection screen 62, an OK button 62a is touched.

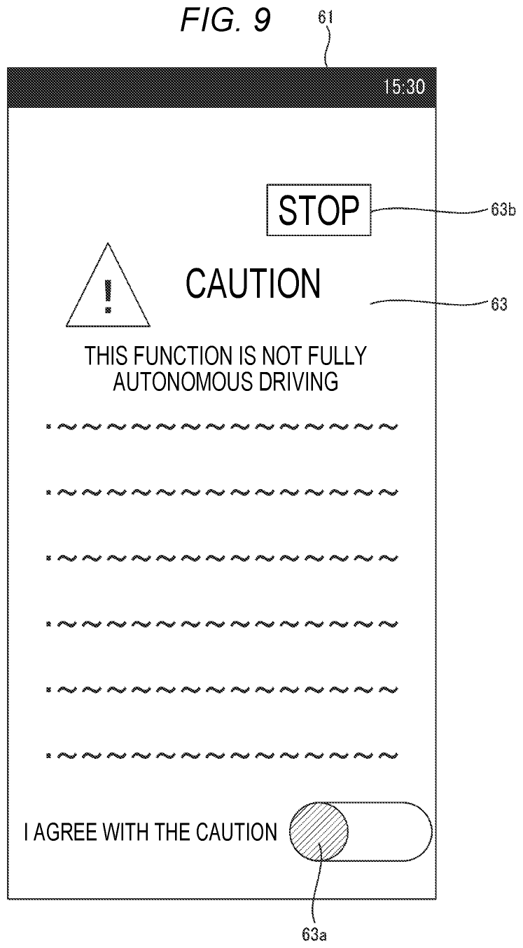

When the authentication code is input and the OK button 62a is touched in step S11, the processor 81 displays, for example, a disclaimer notification and agreement screen 63 stipulated relative to autonomous parking on the terminal screen 61 as shown in FIG. 9 (step S12). When contents of the disclaimer notification and agreement screen 63 are agreed, an agree button 63a is swiped, and when the contents of the disclaimer notification and agreement screen are not agreed, a stop button 63b for stopping the autonomous parking is touched.

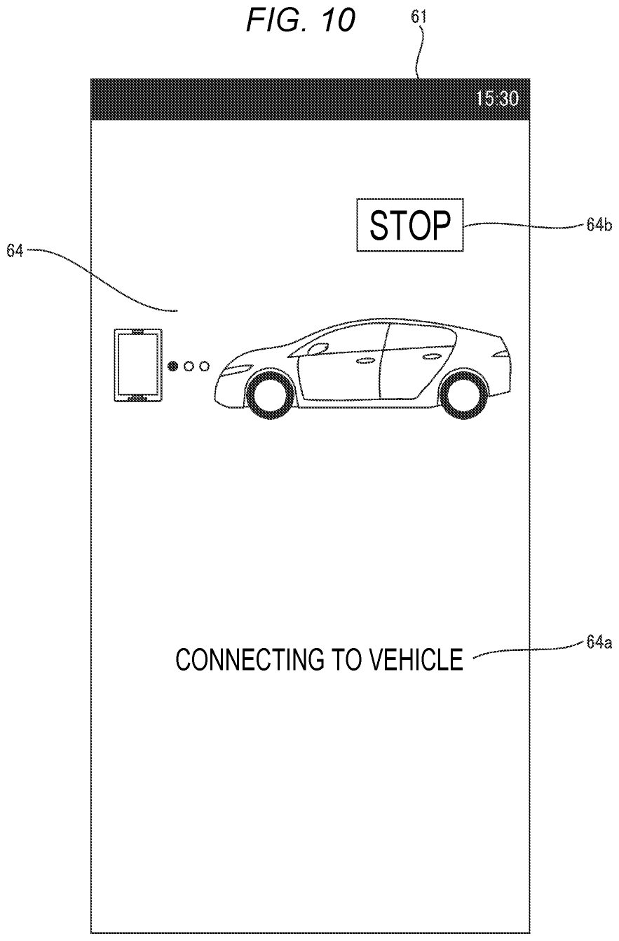

When the agree button 63a is swiped in step S12, the processor 81 starts a process of communication connection with the vehicle 10, and displays, for example, a connection screen 64 as shown in FIG. 10 on the terminal screen 61 (step S13). The processor 81 displays, on the connection screen 64, a connection message 64a indicating that the connection process with the vehicle 10 is in progress, such as “connecting to vehicle”, and a stop button 64b for stopping the connection process.

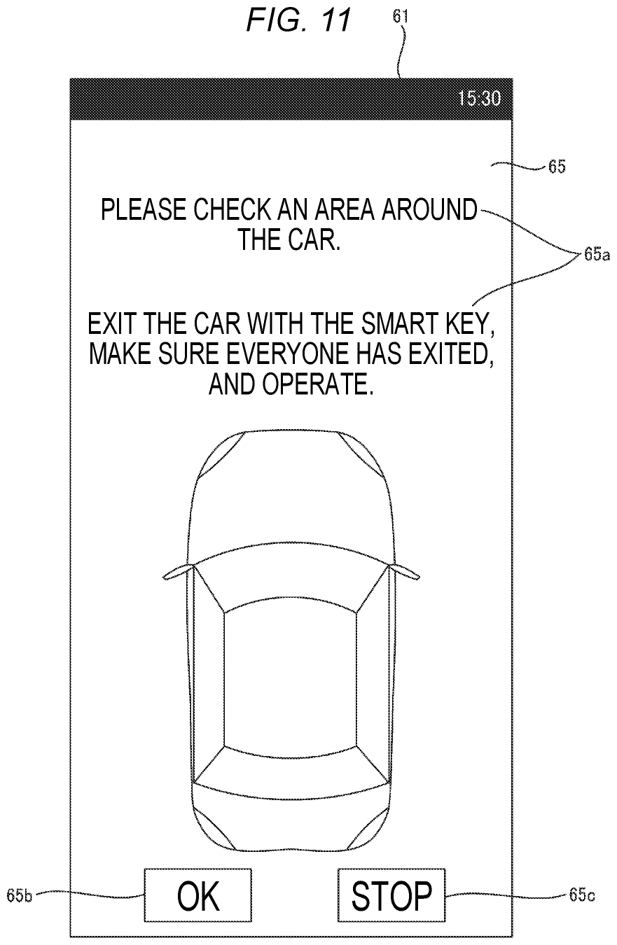

When the communication connection with the vehicle 10 in step S13 is completed, the processor 81 displays, for example, an alighting guidance screen 65 as shown in FIG. 11 on the terminal screen 61 (step S14). The processor 81 displays, on the alighting guidance screen 65, a determination message 65a that prompts the user to get off the vehicle 10 and prompts the user to perform a next operation, such as “Please check an area around the car. Exit the car with the smart key, make sure everyone has exited, and operate”. In addition, the processor 81 displays, on the alighting guidance screen 65, a determination button 65b indicating that the determination message 65a is checked and a stop button 65c for stopping the operation.

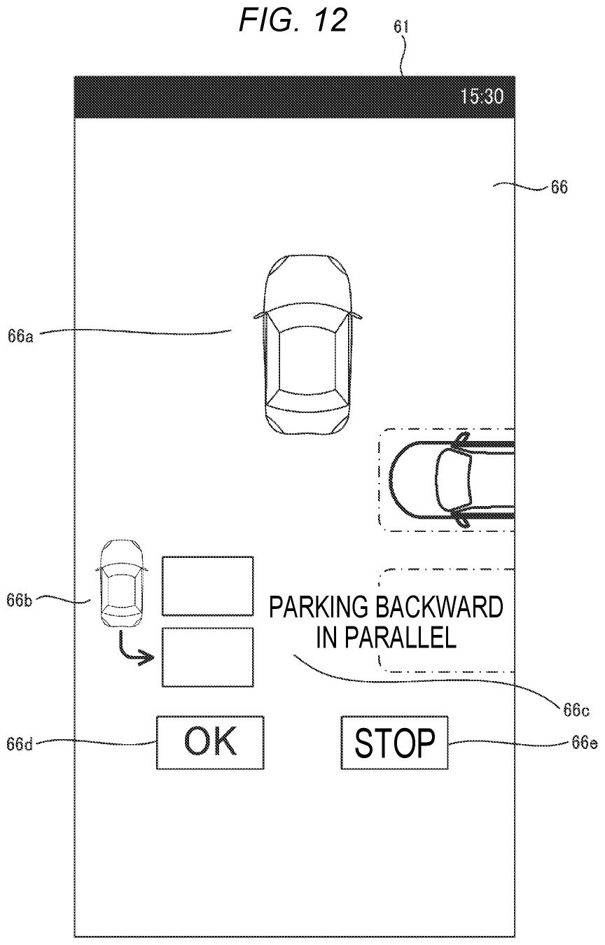

When the determination button 65b is touched in step S14, the processor 81 displays, for example, an action plan screen 66 as shown in FIG. 12 on the terminal screen 61 (step S15). The processor 81 displays, on the action plan screen 66, an overhead view image 66a of the surroundings of the vehicle 10 received from the vehicle 10 and a scheduled parking image 66b indicating the parking space of the vehicle 10 received from the vehicle 10. For example, a parking message 66c such as “parking backward in parallel” may be added to the scheduled parking image 66b. In addition, the processor 81 displays, on the action plan screen 66, an OK button 66d indicating that the autonomous parking can be started according to this content, and a stop button 66e for stopping the autonomous parking.

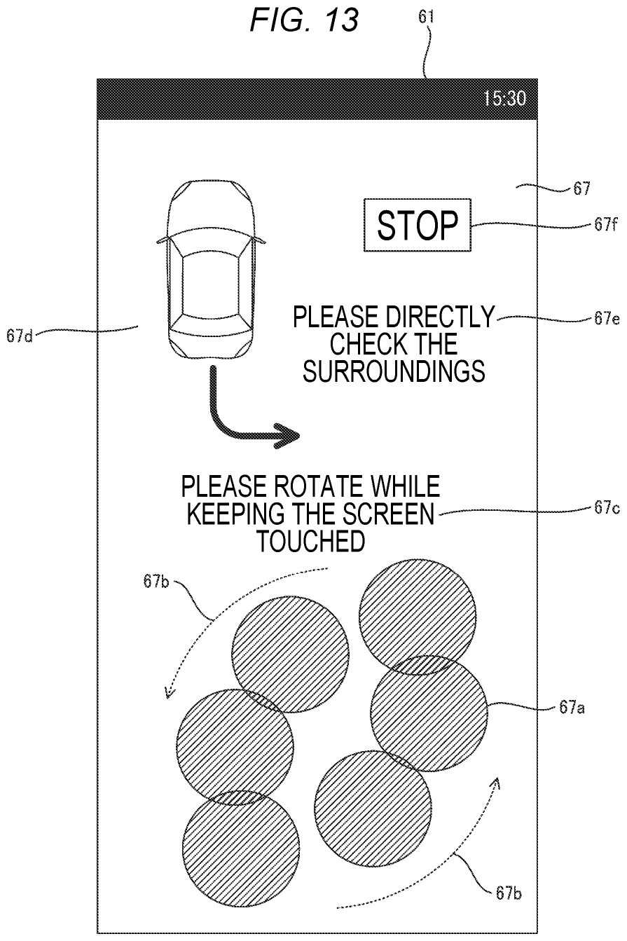

When the OK button 66d is touched in step S15, the processor 81 displays an operation input start screen 67 for guiding start of the autonomous parking on the terminal screen 61, for example, as shown in FIG. 13 (step S16). The processor 81 displays, on the operation input start screen 67, an image in which six spheres 67a rotate counterclockwise in a direction indicated by an arrow 67b, for example. That is, an image prompting a rotational swipe operation of sliding in a counterclockwise direction on the terminal screen 61 is displayed. In addition, the processor 81 displays, on the operation input start screen 67, a guidance message 67c such as “please rotate while keeping the screen touched”. In addition, the processor 81 displays, on the operation input start screen 67, a vehicle image 67d indicating that the vehicle 10 is parked backward and a reminder message 67e such as “Please directly check the surroundings”. Further, the processor 81 displays, on the operation input start screen 67, a stop button 67f for stopping the autonomous parking. The rotational swipe operation is a gesture of swiping rotationally.

Next, the processor 81 determines whether a rotational swipe operation is started on the terminal screen 61 (step S17).

In step S17, when no rotational swipe operation is started (step S17: No), the processor 81 repeats the process of step S17 and stands by until the rotational swipe operation is started.

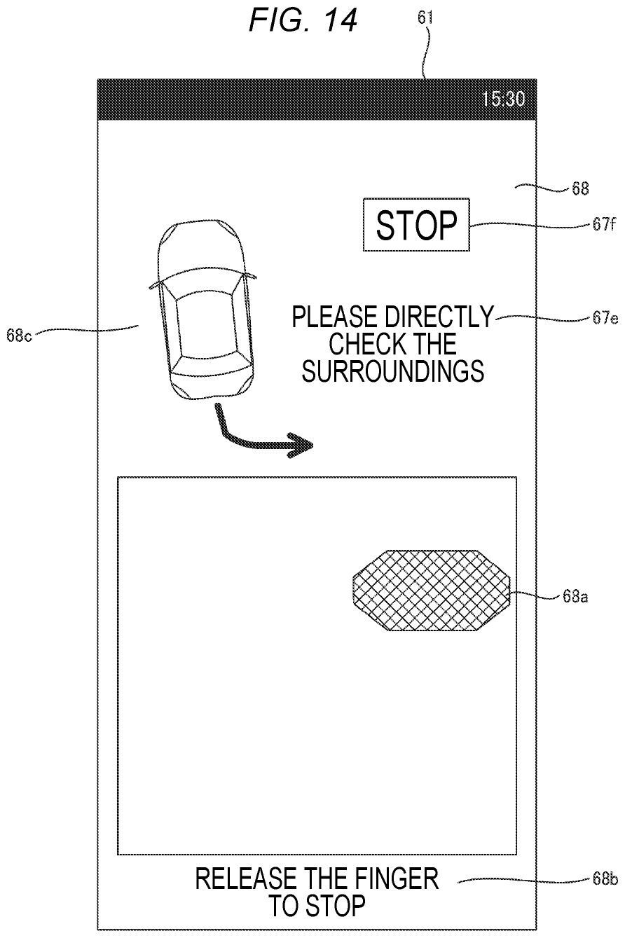

In step S17, when the rotational swipe operation is started (step S17: Yes), the processor 81 displays, for example, as shown in FIG. 14, an operation input screen 68 indicating a state in which the rotational swipe operation is performed during parking on the terminal screen 61 (step S18). The processor 81 displays, on the operation input screen 68, a movement icon 68a that moves following a position touched by the rotational swipe operation of the user M, for example. In addition, the processor 81 displays a guidance message 68b for stopping the autonomous parking of the vehicle 10, such as “release the finger to stop”, for example. In addition, the processor 81 displays, on the operation input screen 68, a vehicle image 68c indicating that backward parking of the vehicle 10 is in progress, and a reminder message 67e and a stop button 67f as in FIG. 13. In this way, when the rotational swipe operation is performed on the terminal screen 61, the movement icon 68a rotationally moves following the touch position, and the vehicle 10 starts to move according to the rotational movement. In addition, when a finger performing the rotational swipe operation is released from the terminal screen 61, or when the rotational swipe operation is stopped, movement of the autonomous parking of the vehicle 10 is temporarily stopped.

Next, the processor 81 transmits a parking instruction signal to the vehicle 10 to start the autonomous parking of the vehicle 10 (step S19). When the parking instruction signal is received from the information terminal 60, the autonomous parking control unit 55 of the vehicle 10 starts the autonomous parking of the vehicle 10 according to the received parking instruction signal.

Next, the processor 81 determines whether the autonomous parking is completed, that is, whether the parking of the vehicle 10 in the parking space selected by the user M is completed (step S20). Whether the autonomous parking is completed can be determined based on information on autonomous parking execution control transmitted from the autonomous parking control unit 55 of the vehicle 10.

In step S20, when the autonomous parking is not completed (step S20: No), the processor 81 repeats the process of step S20 and stands by until the autonomous parking is completed.

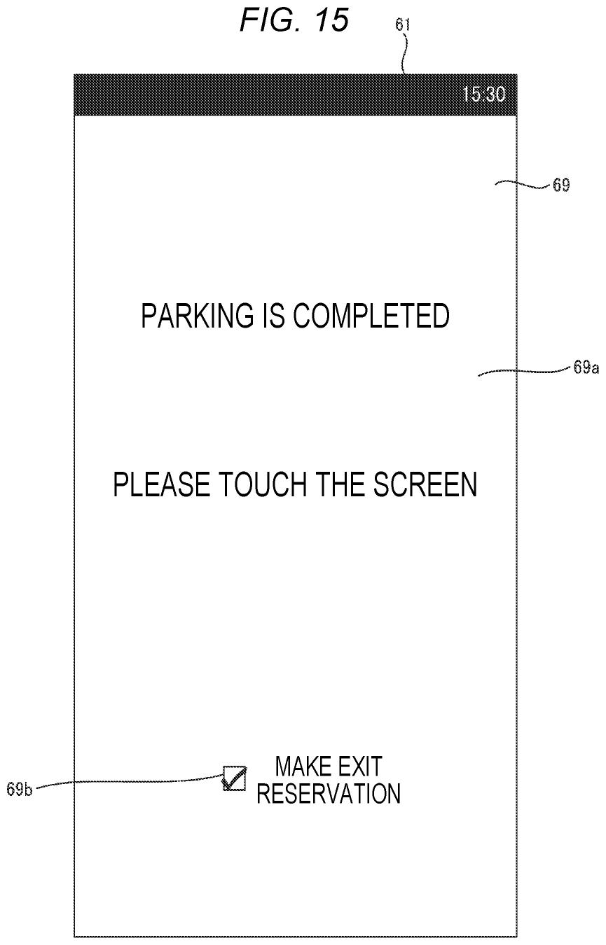

In step S20, when the autonomous parking is completed (step S20: Yes), the processor 81 displays, for example, an autonomous parking completion screen 69 as shown in FIG. 15 on the terminal screen 61 (step S21). The processor 81 displays, on the autonomous parking completion screen 69, for example, a parking completion message 69a such as “Parking is completed. Please touch the screen.” In addition, the processor 81 displays, on the autonomous parking completion screen 69, a check box 69b for making an autonomous exit reservation.

On the autonomous parking completion screen 69, the user M touches the terminal screen 61 after checking the check box 69b when the autonomous exit reservation is necessary and touches the terminal screen 61 without checking the check box 69b when the autonomous exit reservation is not necessary.

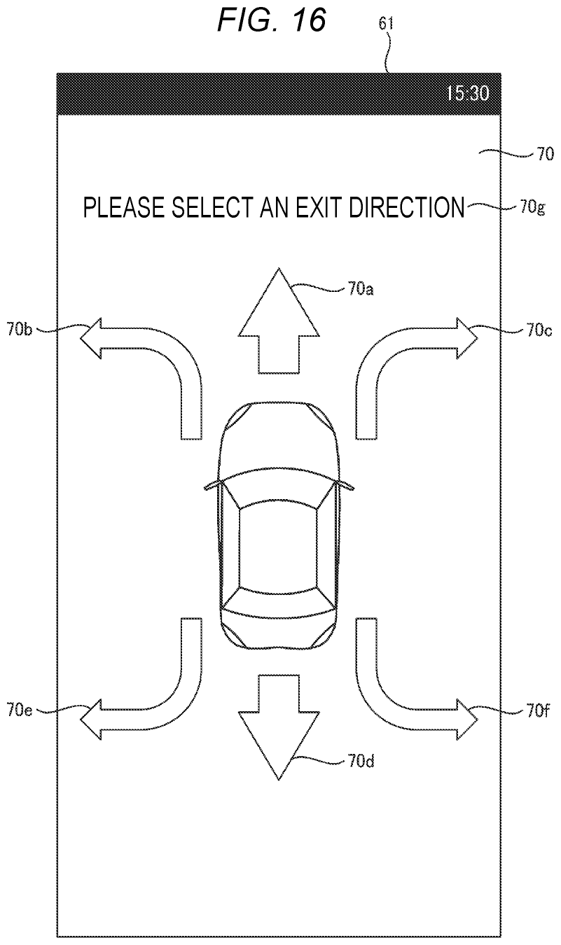

When the terminal screen 61 is touched after the exit reservation check box 69b is checked on the autonomous parking completion screen 69, the processor 81 displays, for example, an exit direction selection screen 70 for selecting the exit direction (action plan) of autonomous exit as shown in FIG. 16 on the terminal screen 61. The processor 81 displays, on the exit direction selection screen 70, for example, a forward exit 70a of moving forward and stopping after exiting the parking space, a forward left turn exit 70b of moving forward, turning left and stopping after exiting the parking space, a forward right turn exit 70c of moving forward, turning right and stopping after exiting the parking space, a backward exit 70d of moving backward and stopping after exiting the parking space, a backward left turn exit 70e of moving backward, turning left and stopping after exiting the parking space, and a backward right turn exit 70f of moving backward, turning right and stopping after exiting the parking space. In addition, the processor 81 displays, on the exit direction selection screen 70, a selection message 70g such as “please select an exit direction”. On the exit direction selection screen 70, the user M selects, by touching, an exit direction (70a to 700 in which the user M wants the vehicle 10 to exit.

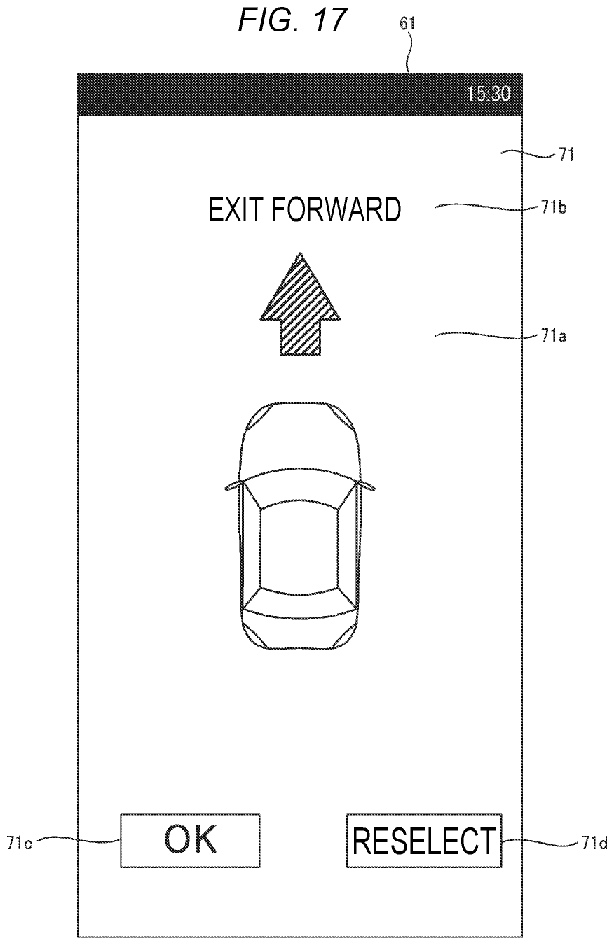

When one of the exit directions is selected on the exit direction selection screen 70, the processor 81 displays, for example, an exit direction determination screen 71 as shown in FIG. 17 on the terminal screen 61. The processor 81 displays, on the exit direction determination screen 71, for example, an exit direction image 71a indicating the selected exit direction and a determination message 71b such as “exit forward”. In addition, the processor 81 displays, on the exit direction determination screen 71, an OK button 71c for determining the exit direction and a reselection button 71d for reselecting the exit direction. When the reselection button 71d is touched, the processor 81 displays the exit direction selection screen 70 shown in FIG. 16 and enables selection of the exit direction again.

Next, the processor 81 determines whether the exit reservation is received, that is, whether the screen proceeds to the exit direction determination screen 71 shown in FIG. 17 and the OK button 71c is touched (step S22).

In step S22, when the exit reservation is received (step S22: Yes), the processor 81 stores exit reservation information including the selected exit direction in the memory 82 (step S23), and then ends the present parking instruction control during autonomous parking. The processor 81 discards the exit reservation information including the selected exit direction (action plan) after a predetermined time since the exit reservation information is stored in the memory 82. However, the predetermined time during which the exit reservation information can be stored can be set by the user M.

In step S22, when no exit reservation is received (step S22: No), the processor 81 ends the present parking instruction control directly.

### <Processing Performed by Information Terminal 60 During Autonomous Exit>

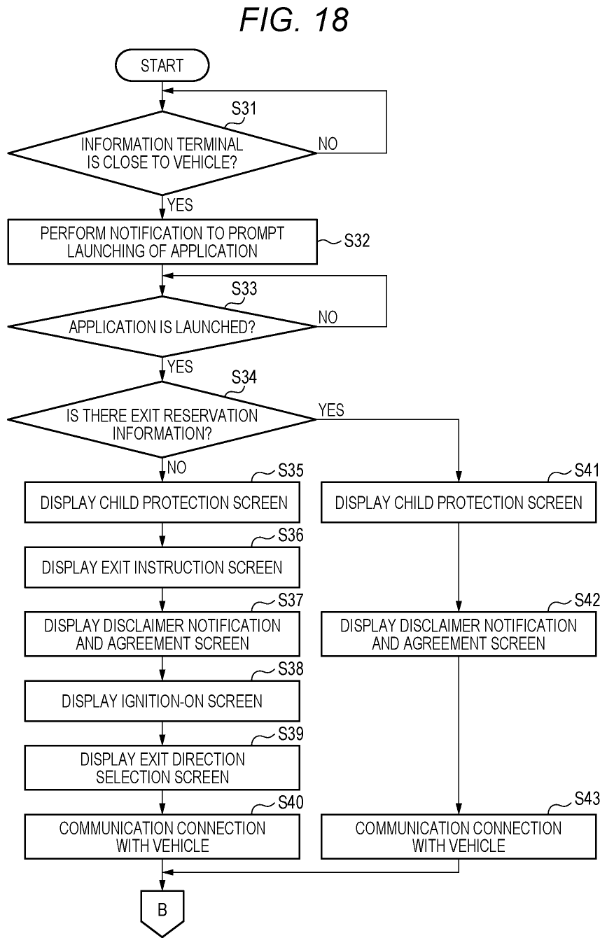

Next, an example of exit instruction control performed by the information terminal 60 during autonomous exit will be described with reference to FIGS. 18 to 25.

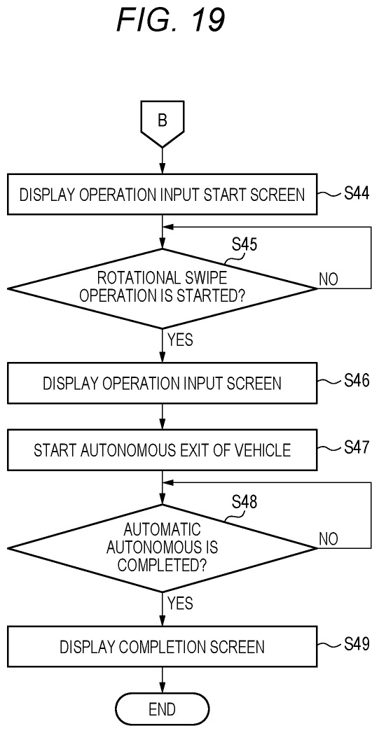

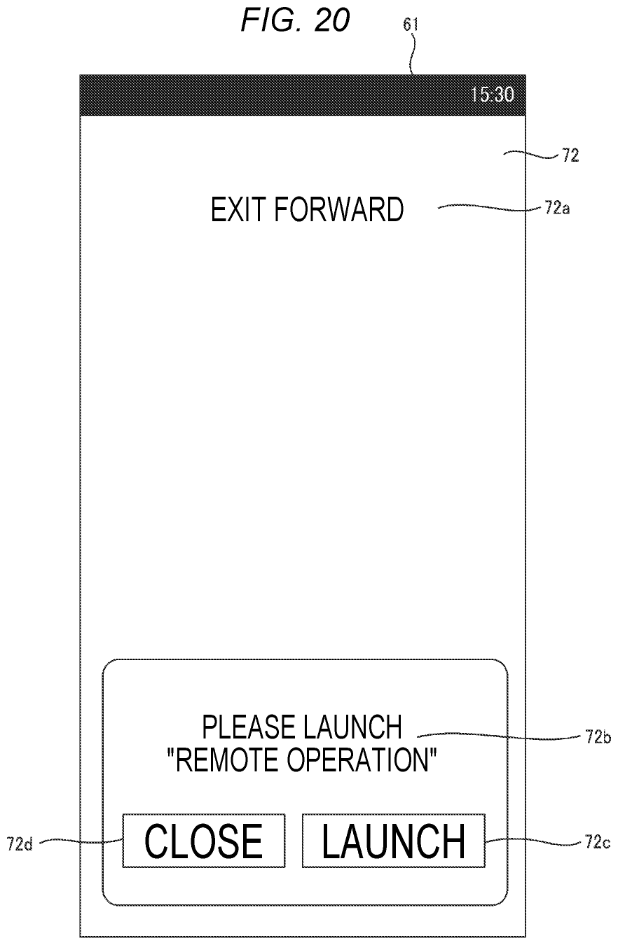

FIGS. 18 and 19 are flowcharts showing the exit instruction control performed by the information terminal 60 during the autonomous exit. FIGS. 20 to 25 show examples of images displayed on the information terminal 60 during the autonomous exit.

For example, the user M attempts to cause the vehicle 10 to exit a parking lot. The user M carries the information terminal 60.

The processor 81 of the information terminal 60 determines whether the information terminal 60 is close to (for example, within predetermined meters from) the vehicle 10, that is, whether the information terminal 60 approaches a distance at which wireless communication with the vehicle 10 is available (step S31).

In step S31, when the information terminal 60 does not approach the vehicle 10 to a distance at which wireless communication is available (step S31: No), the processor 81 repeats the process of step S31 until wireless communication is available.

In step S31, when the information terminal 60 approaches the vehicle 10 to a distance at which wireless communication is available (step S31: Yes), the processor 81 displays, for example, an autonomous exit guidance screen 72 as shown in FIG. 20 on the terminal screen 61, and prompts the user to launch an autonomous exit application of the vehicle 10 (step S32). The processor 81 displays, on the autonomous exit guidance screen 72, for example, a notification message 72a notifying that the autonomous exit of the vehicle 10 is available, such as “exit forward”. In addition, the processor 81 displays, on the autonomous exit guidance screen 72, for example, a notification message 72b prompting the user to launch the autonomous exit application, such as “Please start a remote operation”, a launch button 72c for launching the application, and a close button 72d for closing the autonomous exit guidance screen 72.

Next, the processor 81 determines whether the autonomous exit application is launched (step S33).

In step S33, when the autonomous exit application is not launched (step S33: No), the processor 81 stands by until the application is launched. However, when the application is not launched for a certain time, the processor 81 may autonomously close the autonomous exit guidance screen 72.

In step S33, when the autonomous exit application is launched (step S33: Yes), the processor 81 determines whether the exit reservation information is stored (step S34).

In step S34, when no exit reservation information is stored (step S34: No), the processor 81 displays the child protection screen 62 as shown in FIG. 8 on the terminal screen 61, as in step S11 shown in FIG. 6 (step S35).

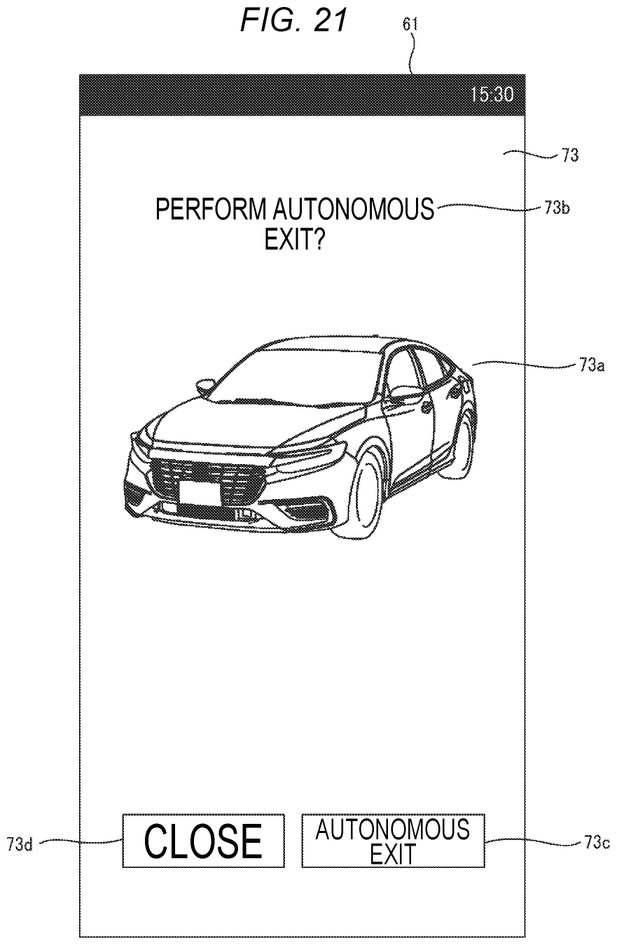

When the OK button 62a is touched after the predetermined authentication code is input in step S35, the processor 81 displays, for example, as shown in FIG. 21, an exit instruction screen 73 for determining whether to perform the autonomous exit on the terminal screen 61 (step S36). The processor 81 displays, on the exit instruction screen 73, for example, a vehicle image 73a of the vehicle 10 and a determination message 73b such as “Perform autonomous exit?”. In addition, the processor 81 displays, on the exit instruction screen 73, an autonomous exit button 73c to be touched when the autonomous exit is to be performed, and a close button 73d for closing the exit instruction screen 73 when the autonomous exit is not to be performed.

When the autonomous exit button 73c is touched in step S36, the processor 81 displays the disclaimer notification and agreement screen 63 as shown in FIG. 9 on the terminal screen 61, as in step S12 shown in FIG. 6 (step S37).

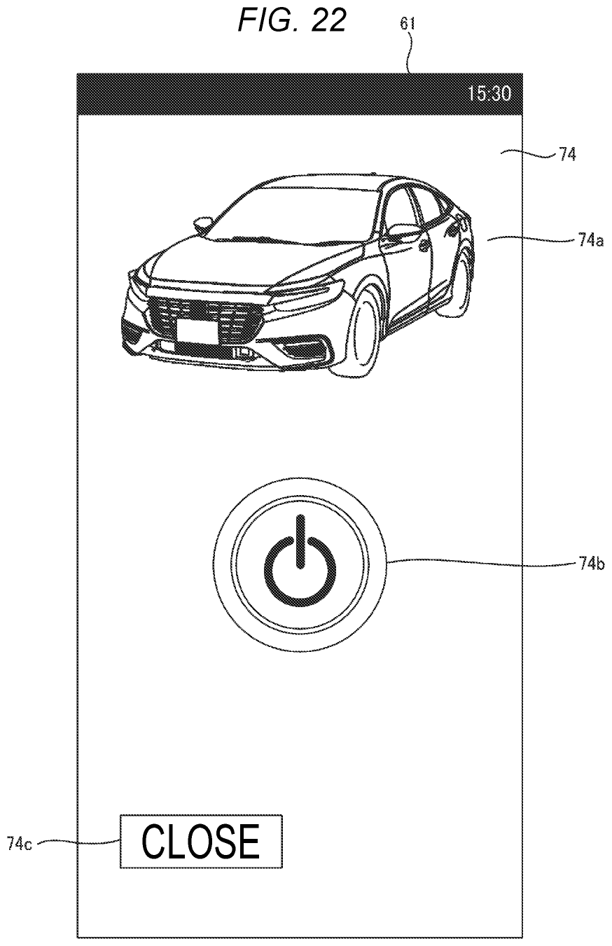

When the agree button 63a is swiped in step S37, the processor 81 displays, for example, an ignition-on screen 74 as shown in FIG. 22 on the terminal screen 61 to prompt selection of the exit direction of the vehicle 10 during the exit (step S38). The processor 81 displays, on the ignition-on screen 74, for example, a vehicle image 74a of the vehicle 10 and an ignition-on button 74b for performing the autonomous exit. In addition, the processor 81 displays, on the ignition-on screen 74, a close button 74c for closing the ignition-on screen 74 when the autonomous exit is to be stopped.

When the ignition-on button 74b is touched in step S38, the processor 81 displays the exit direction selection screen 70 as shown in FIG. 16 on the terminal screen 61, as in step S21 shown in FIG. 7 (step S39). In addition, when one of the exit directions is selected on the exit direction selection screen 70, the processor 81 displays the exit direction determination screen 71 as shown in FIG. 17 on the terminal screen 61.

In step S39, when the OK button 71c is touched on the exit direction determination screen 71 in FIG. 17, the processor 81 displays the connection screen 64 as shown in FIG. 10 on the terminal screen 61, as in step S13 shown in FIG. 6 (step S40). When the communication connection with the vehicle 10 is completed, the processor 81 transmits autonomous exit information including the exit direction selected during the exit in step S39 to the vehicle 10.

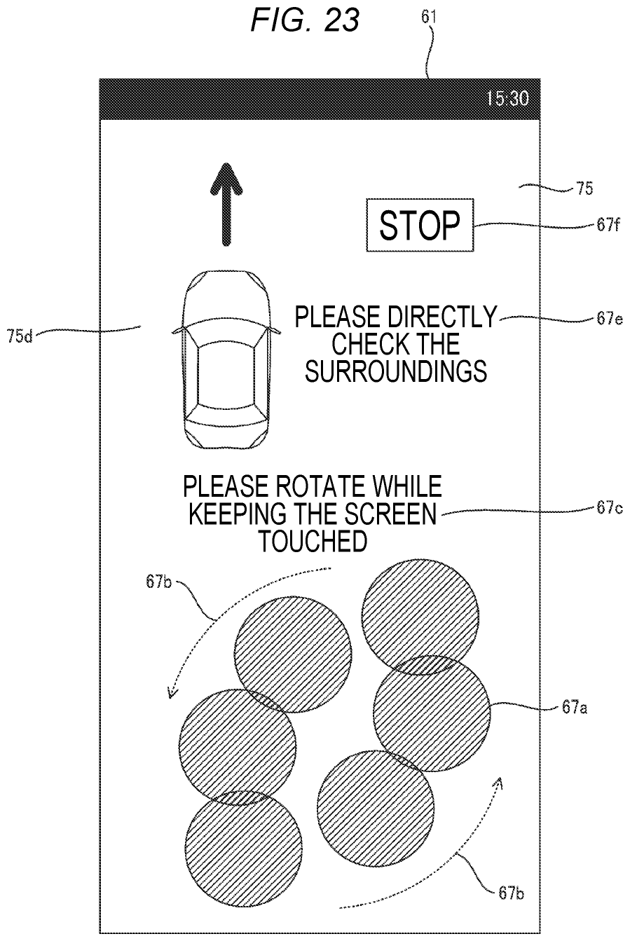

Next, for example, as shown in FIG. 23, the processor 81 displays an operation input start screen 75 for guiding start of the autonomous exit on the terminal screen 61 (step S44). As compared with the operation input start screen 67 guiding the start of the autonomous parking in FIG. 13 described in step S16 shown in FIG. 7, contents displayed on the operation input start screen 75 differ only in that a vehicle image 75d indicating that the vehicle 10 exits forward is different from the vehicle image 67d indicating that the vehicle 10 is parked backward, and the rest (67a to 67c, 67e and 67f) are similar.

On the other hand, in step S34, when the exit reservation information is stored (step S34: Yes), the processor 81 displays the child protection screen 62 as shown in FIG. 8 on the terminal screen 61, as in step S11 shown in FIG. 6 (step S41).

When the OK button 62a is touched after the predetermined authentication code is input in step S41, the processor 81 displays the disclaimer notification and agreement screen 63 as shown in FIG. 9 on the terminal screen 61, as in step S12 shown in FIG. 6 (step S42).

When the agree button 63a indicating agreement with the contents of the disclaimer notification and agreement screen 63 is swiped in step S42, the processor 81 displays the connection screen 64 as shown in FIG. 10 on the terminal screen 61, as in step S13 shown in FIG. 6 (step S43). When the communication connection with the vehicle 10 is completed, the processor 81 transmits the exit reservation information including the exit direction selected during parking, which is stored in step S23 shown in FIG. 7, to the vehicle 10. Then, the processor 81 proceeds to step S44, and displays the operation input start screen 75 as shown in FIG. 23 on the terminal screen 61.

Next, the processor 81 determines whether a rotational swipe operation is started on the terminal screen 61 (step S45).

In step S45, when no rotational swipe operation is started (step S45: No), the processor 81 repeats the process of step S45 and stands by until the rotational swipe operation is started.

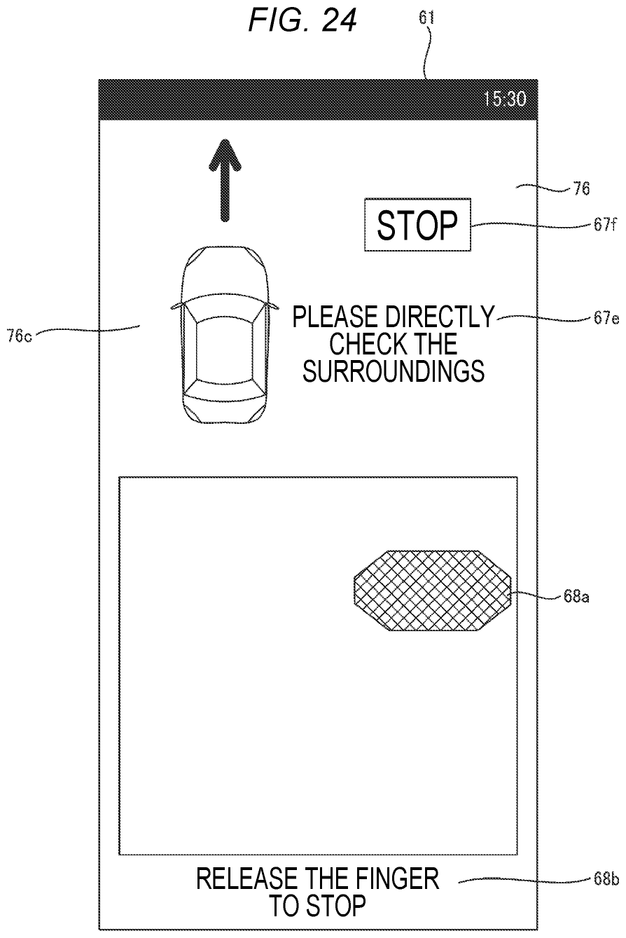

In step S45, when the rotational swipe operation is started (step S45: Yes), the processor 81 displays, for example, as shown in FIG. 24, an operation input screen 76 indicating a state in which the rotational swipe operation is performed during exit on the terminal screen 61 (step S46). As compared with the operation input screen 68 showing the state in which the rotational swipe operation during parking in FIG. 14 described in step S18 shown in FIG. 7, contents displayed on the operation input screen 76 differs only in that a vehicle image 76c indicating that forward exit of the vehicle 10 is in progress is different from the vehicle image 68c indicating that backward parking of the vehicle 10 is in progress, and the rest (68a, 68b, 67e and 67f) are similar.

Next, the processor 81 transmits an exit instruction signal to the vehicle 10 to start the autonomous exit of the vehicle 10 (step S47). When the exit instruction signal is received from the information terminal 60, the autonomous parking control unit 55 of the vehicle 10 starts the autonomous exit of the vehicle 10 based on the autonomous exit information including the exit direction selected during exit or the exit reservation information including the exit direction selected during parking according to the received exit instruction signal.

Next, the processor 81 determines whether the autonomous exit is completed, that is, whether the exit of the vehicle 10 in the exit direction selected by the user M is completed (step S48). Whether the autonomous exit is completed can be determined based on information on autonomous exit execution control transmitted from the autonomous parking control unit 55 of the vehicle 10.

In step S48, when the autonomous exit is not completed (step S48: No), the processor 81 repeats the process of step S48 and stands by until the autonomous exit is completed.

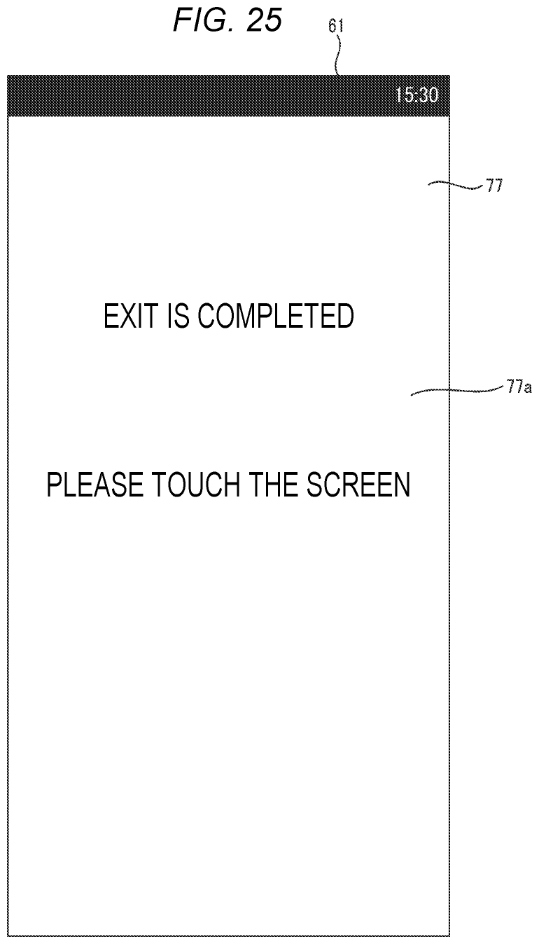

In step S48, when the autonomous exit is completed (step S48: Yes), the processor 81 displays, for example, an autonomous exit completion screen 77 as shown in FIG. 25 on the terminal screen 61 (step S49). The processor 81 displays, on the autonomous exit completion screen 77, for example, an exit completion message 77a such as “Exit is completed. Please touch the screen.” When the terminal screen 61 is touched on the autonomous exit completion screen 77, the processor 81 ends the present exit instruction control during autonomous exit.

As described above, the processor 81 of the information terminal 60 is configured to perform the parking control and the exit control of the vehicle 10 and be capable of receiving the exit control action plan in advance during the parking control. When the exit control action plan is not received in advance, the exit control action plan is received during the exit control of the vehicle 10, and the exit control is performed based on the received action plan. On the other hand, when the exit control action plan is received in advance, the exit control is performed based on the action plan received in advance during the exit control of the vehicle 10. Accordingly, since the exit control action plan when the vehicle 10 is about to exit is received in advance at the time of parking completion when driving of the vehicle 10 ends and the user M is not mentally occupied, it is possible to omit reception of the exit control action plan during the exit. Therefore, it is possible to omit a predetermined operation related to the action plan of the user M during the exit when driving is about to start. Therefore, a burden on the user M can be reduced, and usability regarding the autonomous exit control of the vehicle 10 can be improved.

In addition, when the parking of the vehicle 10 is completed, the processor 81 of the information terminal 60 displays the check box 69b for making the autonomous exit reservation and the exit direction selection screen 70 for selecting the exit direction of autonomous exit on the terminal screen 61, and performs notification that prompts the user M to input the exit control action plan. Accordingly, the user M can easily input the action plan based on the notification displayed on the information terminal 60. In addition, the input of the action plan is simple since the exit directions of the vehicle 10 displayed on the exit direction selection screen 70 can be selected.

In addition, the processor 81 of the information terminal 60 performs the process of discarding the received exit control action plan after a predetermined time set in advance. Therefore, it is possible to prevent a situation in which the user M is confused since the exit control of the vehicle 10 is performed based on an action plan input by the user M a long time ago, for example, when the user M forgets that the action plan is input.

In addition, the processor 81 of the information terminal 60 can receive the exit control action plan based on an input operation input to the information terminal 60 carried by the user M of the vehicle 10. Therefore, it is not necessary to enter the vehicle 10 and input the action plan into an input operation unit of the vehicle 10, and thus it is possible to operate remotely.

In addition, in a case where the exit control action plan is received in advance, the processor 81 of the information terminal 60 displays the autonomous exit application on the terminal screen 61 so as to launch the autonomous exit application and notifies the user M that the exit control is available when the information terminal 60 carried by the user M is close to the vehicle 10. Accordingly, the user M can easily start the autonomous exit of the vehicle 10 based on the notification displayed on the information terminal 60.

Although the embodiment of the present disclosure is described above, the present disclosure is not limited to the above embodiment, and modifications, improvements, and the like can be made as appropriate.

For example, in the above embodiment, the case where the autonomous exit is executed based on the exit reservation information when the exit reservation of the autonomous exit is already received during the exit of the vehicle 10 is described, but the present disclosure is not limited thereto. For example, even when the exit reservation is received, the exit direction may be reset when the exit direction of the vehicle 10 is desired to be changed to a direction different from the reserved direction during the exit.

In addition, in the above embodiment, the case where the user M gets off the vehicle and performs the parking instruction control for autonomous parking and the exit instruction control for autonomous exit by using the information terminal 60 from the outside of the vehicle 10 is described, but the present disclosure is not limited thereto. For example, the parking instruction control for autonomous parking and the exit instruction control for autonomous exit may be performed by using the information terminal 60 from inside the vehicle 10 in a state in which the user M is in the vehicle 10.

In addition, in the above embodiment, a case where the information terminal 60 as an example of the control device instructs the movement control of the vehicle 10 is described, but the present disclosure is not limited thereto. For example, an in-vehicle device mounted on the vehicle 10 may be an example of the control device, and the in-vehicle device may instruct the movement control of the vehicle 10. Further, a combination of the information terminal 60 and an in-vehicle device may be an example of the control device, and the movement control of the vehicle 10 may be instructed by cooperation of the information terminal 60 and the in-vehicle device.

In addition, in the above embodiment, an example in which the moving object is a vehicle (a four-wheeled automobile) is described, but the moving object is not limited thereto. For example, the moving object may be a two-wheeled vehicle or a Segway. Further, the concept of the present disclosure can be applied not only to a vehicle but also to a robot, a ship, an aircraft, or the like that is provided with a driving source and is movable by power of the driving source.

The control method described in the above embodiment can be implemented by executing a control program prepared in advance on a computer. The control program is recorded in a computer-readable storage medium and is executed by being read from the storage medium. In addition, the control program may be provided in a form stored in a non-transitory storage medium such as a flash memory or may be provided via a network such as the Internet. The computer that executes the control program may be provided in a control device, may be provided in an electronic device such as a smartphone, a tablet terminal, or a personal computer capable of communicating with the control device or may be provided in a server device capable of communicating with the control device and the electronic device.

In addition, at least the following matters are described in the present specification. Although corresponding constituent elements and the like in the above embodiment are shown in parentheses, the present disclosure is not limited thereto.

(1) A control device (information terminal 60) of a moving object (vehicle 10), including:
a controller (processor 81) configured to perform parking control and exit control of the moving object and receive an action plan of the exit control, in which
the controller is configured to receive the action plan in advance during the parking control,
when the action plan is not received in advance during the exit control, the controller receives the action plan and performs the exit control based on the received action plan, and
when the action plan is received in advance during the exit control, the controller performs the exit control based on the action plan received in advance.

According to (1), since the action plan is received during parking when driving ends and a user is not mentally occupied, the reception of the action plan can be omitted during exit, a burden on the user can be reduced, and thus usability is improved.

(2) The control device according to (1), in which
during the parking control, the controller performs notification to prompt a user (user M) of the moving object to input the action plan.

According to (2), the user can input the action plan based on the notification, the burden on the user during exit can be reduced, and thus the usability is improved.

(3) The control device according to (1) or (2), in which
the action plan includes an exit direction of the moving object during the exit control.

According to (3), since selection of the exit direction during exit is received as the action plan, the burden on the user during exit can be reduced, and thus usability is improved.

(4) The control device according to any one of (1) to (3), in which
the controller performs a process of discarding the action plan after a predetermined time since the action plan is received.

According to (4), it is possible to prevent a situation in which the user is confused since the exit control is performed based on an action plan input by the user a long time ago (an action plan forgotten by the user) during exit, and thus usability is improved.

(5) The control device according to any one of (1) to (4), in which
the controller is configured to receive the action plan based on an input operation performed on an information terminal carried by the user of the moving object.

According to (5), as compared with a case where the action plan is input by entering a moving object, the user can operate remotely, thus the burden on the user can be reduced, and thus usability is improved.

(6) The control device according to any one of (1) to (5), in which
the controller notifies the user that the exit control based on the action plan is available when the information terminal carried by the user of the moving object is close to the moving object and the action plan is received in advance.

According to (6), the user can start the exit control based on the notification, the burden on the user can be reduced, and thus usability is improved.

(7) A control method performed by a processor of a control device, in which
the processor is configured to perform parking control and exit control of a moving object and receives an action plan of the exit control,
the processor is configured to receive the action plan in advance during the parking control, and
the control method comprises:
when the action plan is not received in advance during the exit control, receiving the action plan and performs the exit control based on the received action plan; and
when the action plan is received in advance during the exit control, performing the exit control based on the action plan received in advance.

According to (7), since the action plan is received during parking when driving ends and the user is not mentally occupied, the reception of the action plan can be omitted during exit, the burden on the user can be reduced, and thus usability is improved.

(8) A non-transitory computer-readable recording medium that stores a control program for causing a processor of a control device to execute a process,
wherein the processor is configured to perform parking control and exit control of a moving object and receive an action plan of the exit control, and
the process comprises:
enabling reception of the action plan in advance during the parking control;
when the action plan is not received in advance during the exit control, receiving the action plan and performing the exit control based on the received action plan; and
when the action plan is received in advance during the exit control, performing the exit control based on the action plan received in advance.

According to (8), since the action plan is received during parking when driving ends and the user is not mentally occupied, the reception of the action plan can be omitted during exit, the burden on the user can be reduced, and thus usability is improved.

1. A control device of a moving object, comprising:
a controller configured to perform parking control and exit control of the moving object and receive an action plan of the exit control, wherein
the controller is configured to receive the action plan in advance during the parking control;
when the action plan is not received in advance during the exit control, the controller receives the action plan and performs the exit control based on the received action plan; and
when the action plan is received in advance during the exit control, the controller performs the exit control based on the action plan received in advance.

2. The control device according to claim 1, wherein
during the parking control, the controller performs notification to prompt a user of the moving object to input the action plan.

3. The control device according to claim 1, wherein
the action plan includes an exit direction of the moving object during the exit control.

4. The control device according to claim 1, wherein
the controller performs a process of discarding the action plan after a predetermined time since the action plan is received.

5. The control device according to claim 1, wherein
the controller is configured to receive the action plan based on an input operation performed on an information terminal carried by the user of the moving object.

6. The control device according to claim 1, wherein
the controller notifies the user that the exit control based on the action plan is available, when the information terminal carried by the user of the moving object is close to the moving object and the action plan is received in advance.

7. A control method performed by a processor a control device, wherein
the processor is configured to perform parking control and exit control of a moving object and receive an action plan of the exit control,
the processor is configured to receive the action plan in advance during the parking control, and
the control method comprises:
when the action plan is not received in advance during the exit control, receiving the action plan and performs the exit control based on the received action plan; and
when the action plan is received in advance during the exit control, performing the exit control based on the action plan received in advance.

8. A non-transitory computer-readable recording medium storing a control program for causing a processor of a control device to execute a process, wherein
the processor is configured to perform parking control and exit control of a moving object and receive an action plan of the exit control, and
the process comprises:
enabling reception of the action plan in advance during the parking control;
when the action plan is not received in advance during the exit control, receiving the action plan and performing the exit control based on the received action plan; and
when the action plan is received in advance during the exit control, performing the exit control based on the action plan received in advance.
